(19) United States
(12) Patent Application Publication
(10) Pub. No.: US 2009/0229078 A1
(43) Pub. Date: Sep. 17, 2009

(54) PCW QUICK DISCONNECT TOOL

(76) Inventor: PEDRO RASCON, Austin, TX (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/049,625

(22) Filed: Mar. 17, 2008

(51) Int. Cl. B25G 1/00; F16L 35/00

(52) U.S. Cl. 16/110.1; 403/12; 403/410

(57) ABSTRACT

A tool adapted for tightly joining two assembly parts into each other is disclosed. The tool comprises a first handle and a second handle hinged together to form a pliers tool. Each handle has an arm extending therefrom. Each arm has a slot therein that receives an assembly part. To couple the two parts together, the two handles are squeezed together to bring the arms and hence, the two assembly parts together. A rotatable mechanism may be turned to pull the arms and hence, the assembly parts closer together after the handles have been squeezed together.

### BACKGROUND OF THE INVENTION

1. Field of the Invention

Embodiments of the present invention generally relate to a tool for joining assembly parts and a method for using the tool.

2. Description of the Related Art

The construction of a semiconductor processing apparatus comprises multiple fluid exchange circuits along which diverse fluid media, such as processing gases, cleaning gas, heating/cooling liquids, and the like, are flowed into and out of the apparatus during operation. One of these fluid exchange circuits may comprise a water circuit configured to transport water into the processing apparatus. Water is usually supplied along a conduit that has a first end connected to a water source and a second end securely mounted to an inlet of the water circuit in the processing apparatus. A quick connector assembly is usually provided to securely link and seal the second end of the conduit with the inlet, while allowing quick disconnection.

While the assembly may be called a quick connector assembly, assembling a high pressure water line to an inlet of the water circuit can be a daunting task for a single technician to perform alone. It would be beneficial if a single technician could connect the water line to the inlet.

### SUMMARY OF THE INVENTION

The present invention generally comprises a tool for connecting two assembly parts together. In one embodiment, a tool for joining two assembly parts together comprises a first handle having a first arm extending therefrom, the first arm having a first slot formed therein, a second handle movably coupled to the first handle, a second arm movably coupled to the first handle and to the second handle, the second arm having a second slot formed therein, a rotatable mechanism coupled to the first handle and functioning to pull the second arm closer to the first arm when rotated in a first direction.

In another embodiment, a method of coupling two assembly parts together comprises disposing a first assembly part into a first slot of a first arm of a tool, the tool comprising a first handle having the first arm extending therefrom, a second handle movably coupled to the first handle, a second arm movably coupled to the first handle and to the second handle, the second arm having a second slot formed therein, and a rotatable mechanism coupled to the first handle, disposing a second assembly part into the second slot, moving the second arm closer to the first arm while simultaneously moving the second assembly part closer to the first assembly part, and rotating the rotatable mechanism to urge the first and second assembly parts against each other.

In another embodiment, a hand held tool, comprises a first jaw portion having an elongated shape coupled with a first handle and a second jaw portion having an elongated shape coupled with a second handle and pivotally hinged with the first jaw portion. The first jaw portion and second jaw portion collectively comprise a U-shape. The tool may also comprise a spring-biased coupling member connecting the first handle to the second handle and an adjuster wheel connected to the coupling member at a distal end of the second handle. The adjuster wheel may be adapted to receive a socket wrench. The tool may also comprise a tip coupled with each of the first and second jaw portions. The tip may have a slot carved therein.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a quick connector assembly;

FIG. 2A is a front elevation view showing an embodiment of a hand held tool adapted for connecting a quick connector assembly;

FIG. 2B is a right side elevation view of the hand held tool shown in FIG. 2A; and

FIGS. 3A-3F show stages of assembling a quick connect assembly with a hand tool according to one embodiment of the invention.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The application describes a hand held tool that can facilitate the connection of assembly parts, such as male and female connectors of a quick connector assembly. The hand held tool comprises two handles hinged together and having extended arm portions adapted to compress the assembly parts against each other. In some embodiments, the hand held tool is also suitable for use with a socket wrench. The socket wrench may be connected to the hand held tool, and operated to transmit a coupling force to the jaw portions to compress the assembly parts against each other. The tool may be suitable for coupling an input line to an apparatus, such as a water inlet to a chemical mechanical polishing apparatus. One exemplary apparatus upon which the tool may be used is a REFLEXION™ LK CMP apparatus and a REFLEXION LK ECMP™ apparatus available from Applied Materials, Inc., Santa Clara, Calif. Other suitable apparatus upon which the tool may be used include Centura™, Endura™, and Producer™ apparatus available from Applied Materials, Inc., Santa Clara, Calif. It is to be understood that the invention may be used on other apparatus, including apparatus provided by other manufacturers.

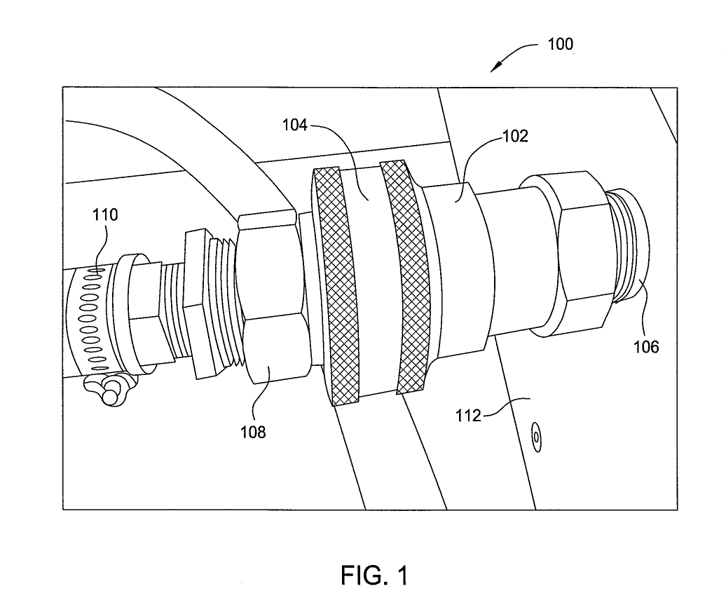

FIG. 1 illustrates a quick connector assembly 100. The quick connector assembly 100 comprises a generally cylindrical female connector 102 coupled to a chamber 112 having a retainer 104 provided on an inlet 106 of the fluid circuit, and a generally cylindrical male connector 108 provided at an end of a conduit 110. In order to assemble the male connector 108 with the female connector 102, the retainer 104 is pulled back, the male connector 108 is inserted into the female connector 102, and the retainer 104 is released or pushed back to the original position.

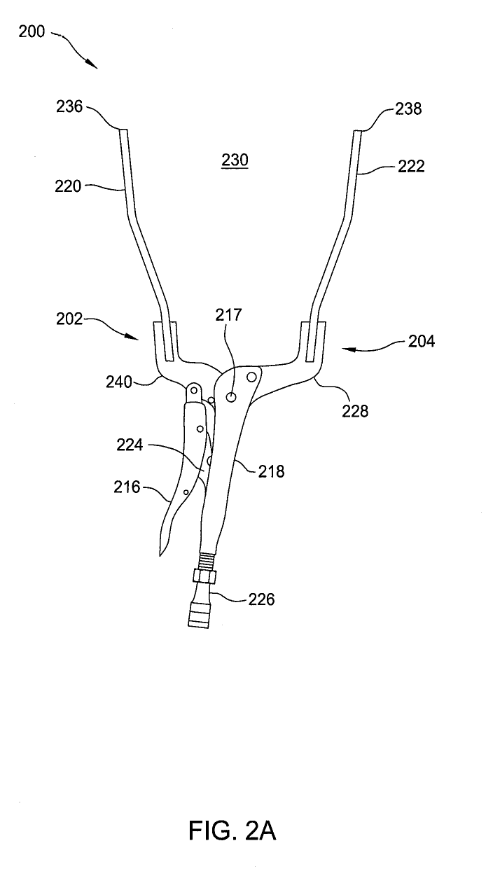

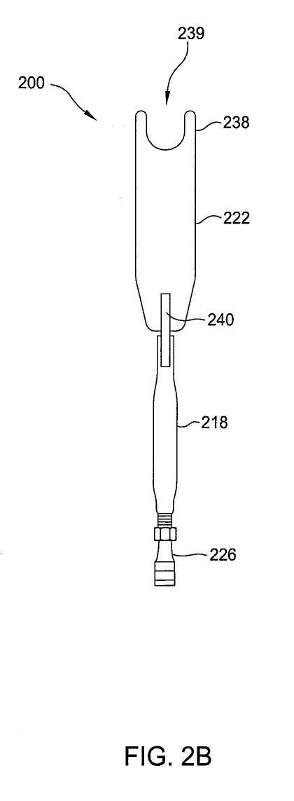

FIG. 2A is a front elevation view showing an embodiment of a hand held tool 200 adapted for connecting assembly parts, such as those of a quick connector assembly. The hand held tool 200 comprises a first arm 202 and a second arm 204 hinged together to form a pliers tool. In one embodiment, the pliers may be configured as locking-grips or locking pliers, also known as vice grips. The first arm 202 and the second arm 204 may be of substantially equal or different length. The first arm 202 is movably coupled to a first handle 216 and has a first jaw portion 220, and the second arm 204 is fixedly coupled to a second handle 218 and has a second jaw portion 222. The second arm 204 is pivotally coupled to the first arm 202 at a pivot point 217. A coupling member, such as spring-biased member 224 also movably couples the second handle 218 to the first handle 216. The spring-biased member 224 is further connected to an adjuster wheel 226 provided at a distal end of the second handle 218. The adjuster wheel 226 comprises an end shaped to couple with a socket wrench. When the adjuster wheel 226 is rotated, the spring-biased member 224 is movable to lock the position of the first arm 202 at a varying distance from the second arm 204 so that the jaw portions 220, 222 exert more or less compression force on assembly parts held between the jaw portions 220, 222. In one embodiment, the first arm 202, the second arm 204, the first handle 216, and the second handle 218 may comprise steel.

As shown in FIG. 2A, each of the jaw portions 220, 222 is formed in a plate shape that is connected to a fork member 240, 228 linking with each of the handles 216, 218, respectively. The jaw portions 220, 222 extend to form a generally U-shape profile that defines a gap 230 between the two jaw portions 220, 222. The gap 230 is dimensioned to receive the assembly parts to join by squeezing action between opposite contact surfaces of the jaw portions 220, 222. Each of the jaw portions 220, 222 may also have a tip 236, 238 configured to facilitate the engagement of the jaw portions 220, 222 on the assembly parts to join.

FIG. 2B is a right side elevation view of the hand held tool 200 of FIG. 2A. As shown, the tip 238 of the jaw portion 222 may be provided with a slot 239 that is adapted to receive an end portion of one of the assembly parts to join. For example, in the case where the assembly parts have a generally cylindrical shape, the slot 239 may have a half circular profile to fit with the cylindrical end portion of the assembly parts. In one embodiment, the slot 239 may also have a diameter between about 0.25 inches and about 0.75 inches. It should be understood that the slot 239 may also be differently shaped and sized to adapt diverse shapes and sizes of the end portions to join. A same slot may be provided on the tip 236 of the other jaw portion 220, aligned with and opened in a same direction as the slot 239. The slot structure provided at the tips 236, 238 allows larger areas of the contact surfaces to be in contact with the assembly parts when the jaw portions 220, 222 are urged against the assembly parts. As a result, the engagement between the jaw portions 220, 222 and the assembly parts to join may be stable.

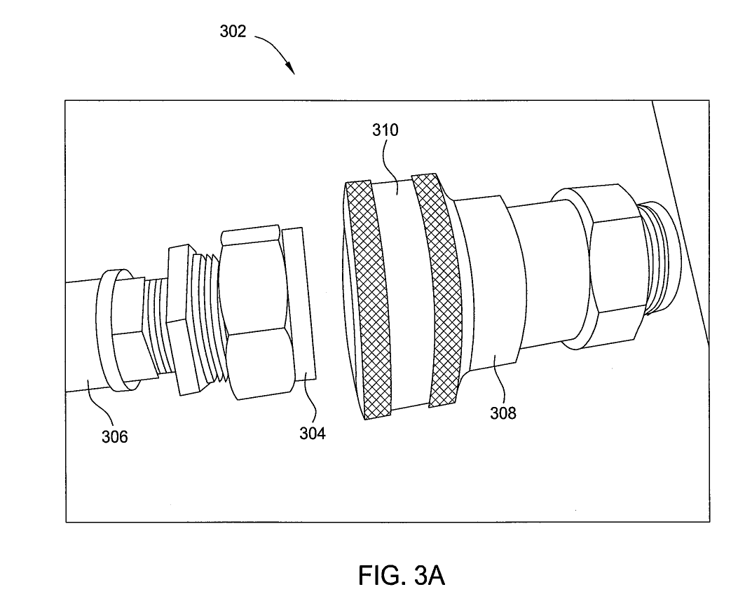

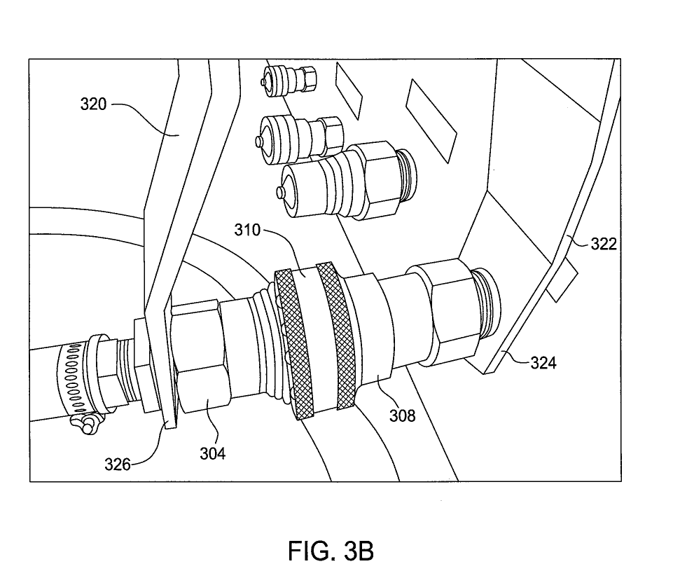

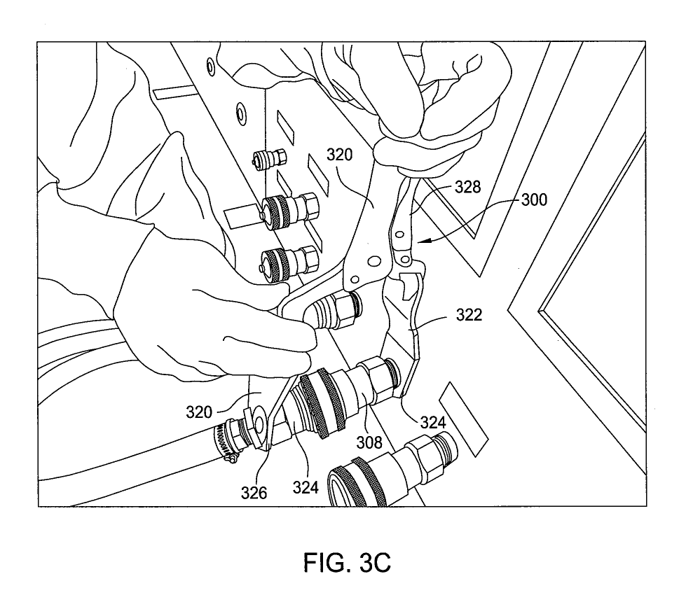

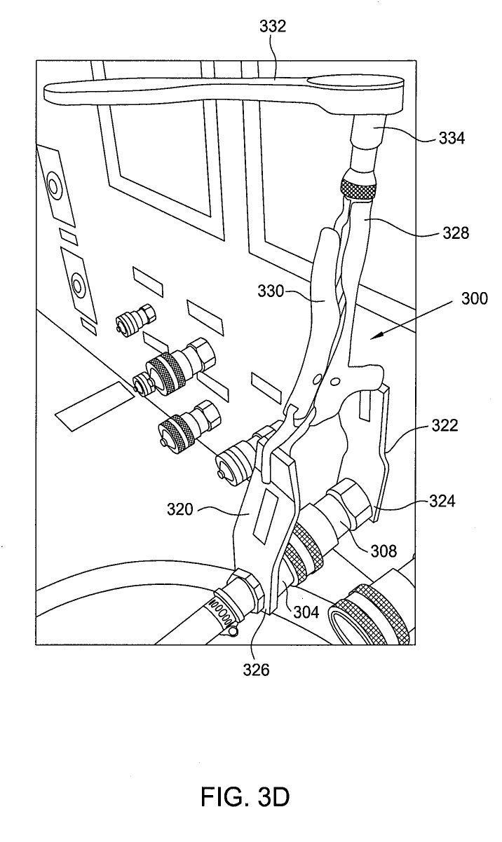

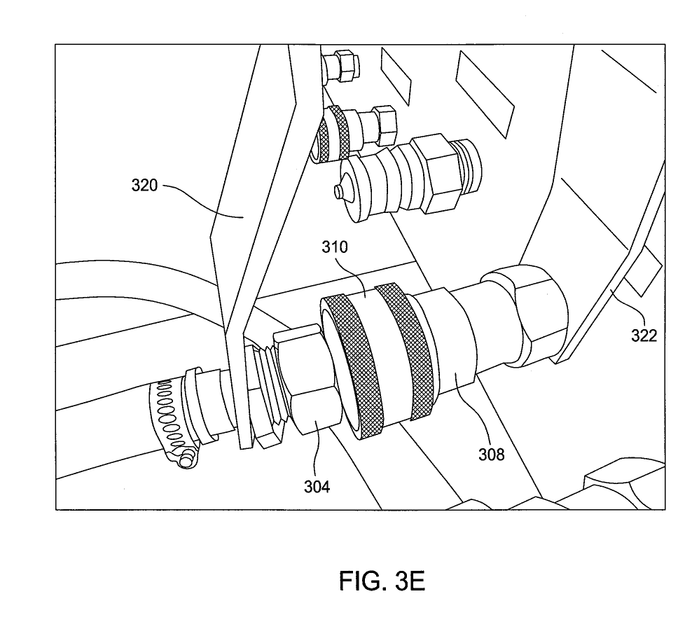

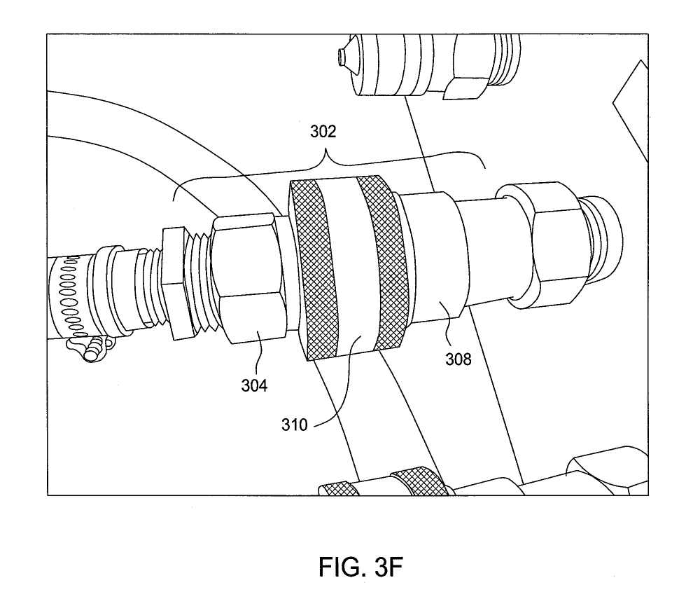

To further illustrate some advantages provided by the hand held tool 300, FIGS. 3A-3F show exemplary use configurations of the tool 300 for joining a quick connector assembly 302. FIG. 3A is a schematic drawing of connector parts that form a quick connector assembly 302. The quick connector assembly 302 comprises a male connector 304 provided at an end of a fluid conduit 306, and a female connector 308 provided at a fluid inlet (not shown). The female connector 308 is coupled with a retainer 310, which is moveable and is used to receive and tighten the male connector 304.

FIG. 3B illustrates an initial stage in the mounting operation of the quick connector assembly 302 by using the hand held tool 300. In one embodiment, the operator inserts the male connector 304 into the female connector 308. In another embodiment, the operator inserts the male connector 304 and the female connector 308 into the tool 300 prior to coupling together. After the male connector 304 is fitted in the female connector 308, the operator positions the hand held tool 300 in an opened state so that the tip 326 of the jaw portion 320 engages with an end of the male connector 304 and the tip 324 of the jaw portion 322 engages with an opposite end of the female connector 308.

FIG. 3C illustrates an intermediate stage in which the hand held tool 300 is operated to securely fit the male and female connectors 304 and 308. After the tips 324 and 326 of the hand held tool 300 have been fitted onto the male and female connectors 304 and 308, the retainer 310 is loosened by the operator to allow the male connector 304 to be better accepted by the female connector 308. The operator then presses on the handles 328 and 330 of the hand held tool 300 to bring the jaw portions 320 and 322 closer to each other, which thereby urge the male and female connectors 304 and 308 into each other.

Instead of pressing on the handles 328 and 330, FIG. 3D illustrates an alternate embodiment in which a socket wrench 332 may be used to bring the jaw portions 320 and 322 closer to each other. After the socket wrench 332 is coupled to the adjuster wheel 334, the operator rotates the socket wrench 332 to cause the jaw portions 320 and 322 to squeeze against the male and female connectors 304 and 308 that thereby tightly fit into each other. After the quick connector assembly 302 is securely joined, the tool 300 may be removed.

FIG. 3E is illustrates the quick connector assembly 302 after the male and female connects have been tightly fitted into each other with the tool 300. The operator can then rotate and retighten the retainer 310. The male and the female connector 304 and 308 are now tightly connected with each other to allow fluid exchange. The tool 300 then may be removed, as shown in FIG. 3F.

By providing the foregoing tool, the operation for connecting assembly parts such as quick connector assemblies is significantly facilitated.

While the foregoing is directed to embodiments of the present invention, other and further embodiments of the invention may be devised without departing from the basic scope thereof, and the scope thereof is determined by the claims that follow.

We claim:

1. A tool for joining two assembly parts together, comprising:
a first handle having a first arm extending therefrom, the first arm having a first slot formed at a tip thereof;
a second handle movably coupled to the first handle;
a second arm movably coupled to the first handle and to the second handle, the second arm having a second slot formed at a tip thereof; and
a rotatable mechanism coupled to the first handle and functioning to pull the second arm closer to the first arm when rotated in a first direction.

2. The tool of claim 1, wherein the first handle, the second handle, and first arm, and the second arm comprise steel.

3. The tool of claim 1, wherein the rotatable mechanism comprises an end shaped to receive a socket wrench.

4. The tool of claim 1, wherein the first and second slots are shaped as half circles.

5. The tool of claim 4, wherein the first and second slots have a diameter between about 0.25 inches and about 0.75 inches.

6. The tool of claim 1, wherein the first arm is fixedly coupled to the first handle.

7. The tool of claim 1, wherein the second arm is coupled to the first handle at a first pivot point.

8. The tool of claim 7, wherein the second arm is coupled to the first handle at a second point with a spring-biased member.

9. The tool of claim 1, wherein the first arm and the second arm are of substantially equal length.

10. The tool of claim 1, wherein the first slot and the second slot are substantially aligned such that any point of the first slot is substantially aligned with a corresponding substantially identical spot on the second slot.

11. A method of coupling two assembly parts together, comprising:
disposing a first assembly part into a first slot of a first arm of a tool, the tool comprising a first handle having the first arm extending therefrom, a second handle movably coupled to the first handle, a second arm movably coupled to the first handle and to the second handle, the second arm having a second slot formed therein, and a rotatable mechanism coupled to the first handle;
disposing a second assembly part into the second slot;
moving the second arm closer to the first arm while simultaneously moving the second assembly part closer to the first assembly part; and
rotating the rotatable mechanism to urge the first and second assembly parts against each other.

12. The method of claim 11, wherein the first assembly part comprises a male connector, and the second assembly part comprises a female connector.

13. The method of claim 11, wherein moving the second arm closer to the first arm comprises moving the second handle closer to the first handle.

14. The method of claim 11, wherein rotating the rotatable mechanism comprises:
coupling a socket wrench to the rotatable mechanism; and
rotating the socket wrench.

15. The method of claim 11, wherein the first and second slots have a half-circle shape.

16. The method of claim 11, wherein the second assembly part moves relative to the first assembly part.

17. A hand held tool, comprising:
a first jaw portion having an elongated shape coupled with a first handle;
a second jaw portion having an elongated shape coupled with a second handle and pivotally hinged with the first jaw portion, the first jaw portion and second jaw portion collectively comprise a U-shape;
a spring-biased coupling member connecting the first handle to the second handle;
an adjuster wheel connected to the coupling member at a distal end of the second handle, wherein the adjuster wheel is adapted to receive a socket wrench; and
a tip coupled with each of the first and second jaw portions, the tip having a slot carved therein.

18. The hand held tool of claim 17, wherein each slot has a diameter between about 0.25 inches and about 0.75 inches.

19. The hand held tool of claim 17, wherein each slot is shaped as a half circle.

20. The hand held tool of claim 17, wherein the slots at the tips of the first and second jaw portions are substantially aligned with each other.
